(19) United States
(12) Patent Application Publication
(10) Pub. No.: US 2026/0148164 A1
(43) Pub. Date: May 28, 2026

(54) INFORMATION PROCESSING APPARATUS

(71) Applicant: EBARA CORPORATION, Tokyo (JP)

(72) Inventor: Shinya TAKUBO, Tokyo (JP)

(73) Assignee: EBARA CORPORATION, Tokyo (JP)

(21) Appl. No.: 19/396,922

(22) Filed: Nov. 21, 2025

(30) Foreign Application Priority Data
Nov. 25, 2024 (JP) 2024-204660

(51) Int. Cl. G06Q 10/0631; G06Q 10/04

(52) U.S. Cl. CPC G06Q 10/06316; G06Q 10/04

(57) ABSTRACT

An information processing apparatus (3) executes, on substrate processing units and a substrate transport unit, first mathematical optimization for determining a start timing of each process on a substrate without setting an exclusive processing condition for selecting one of two processes as a constraint condition of the mathematical optimization, and determines whether there is a substrate processing unit or a substrate transport unit executing processes that are not simultaneously executable based on a result. The apparatus (3) executes second mathematical optimization of determining a start timing of each process on the substrate on the substrate processing unit or the substrate transport unit determined to execute the processes that are not simultaneously executable by adding an exclusive processing condition for determining which process is prioritized between the two processes that are not simultaneously executable among the processes on the substrate to the constraint condition of the first mathematical optimization.

### BACKGROUND

### Technical Field

The present invention relates to an information processing apparatus that has a function of generating a substrate processing schedule.

### Related Art

As one of substrate processing apparatuses that execute various types of processes on a substrate such as a semiconductor wafer, a substrate processing apparatus that executes a chemical mechanical polishing (CMP) process is known. Such a substrate processing apparatus includes, for example, a polishing unit that executes a polishing process of a substrate, a finishing unit that executes a finishing process (for example, a washing process or a drying process) of the substrate after the polishing process, and a transport unit that executes a transporting process of transporting the substrate between the units and is configured to execute a series of processes by sequentially operating the units.

Such a substrate processing apparatus includes a plurality of polishing units, a plurality of finishing units, and a plurality of transport units in order to improve processing efficiency. Therefore, in the substrate processing apparatus, when the units are sequentially operated using a predetermined number of substrates as a processing target, it is required to generate a substrate processing schedule of each process by appropriately determining an operation order and an operation timing of each unit such that a time at which each process on all the substrates is completed is minimized. Accordingly, in the related art, an information processing apparatus that has a function of generating a substrate processing schedule has been proposed (see, for example, JP 2024-027312 A).

However, in the information processing apparatus according to the related art, two processes that cannot be executed simultaneously among the processes executed by each unit are specified in advance, and mathematical optimization is executed using a selection condition (exclusive processing condition) for determining which process is prioritized between the two processes as a constraint condition of the mathematical optimization. Therefore, the number of combinations of processing orders to be selected through the optimization increases, and it takes a relatively long time to generate the substrate processing schedule.

The substrate processing schedule is generated as necessary (for example, whenever the substrate is transported to each unit) during an operation of the substrate processing apparatus. The time taken to generate the substrate processing schedule may be as short as possible. For example, it is desirable to generate the substrate processing schedule in several seconds. Therefore, it was desirable to develop an information processing apparatus capable of generating a substrate processing schedule in a short time.

### SUMMARY

The present invention has been devised under the foregoing circumstances. An object of the present invention is to provide an information processing apparatus capable of generating a substrate processing schedule in a short time.

An aspect of the present invention is an information processing apparatus that generates a substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates. The information processing apparatus includes: an information acquisition unit configured to acquire processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and a scheduling unit configured to determine a start timing of each process on the substrate based on the processing time information acquired by the information acquisition unit such that a processing time from a time at which transport of the first substrate from the substrate housing unit to the first substrate processing unit starts to a time at which transport of the last substrate from the last substrate processing unit to the substrate housing unit ends is minimized. The scheduling unit includes a first mathematical optimization unit configured to execute first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization, an overlap determination unit configured to determine whether there is a substrate processing unit or a substrate transport unit executing processes that are not simultaneously executable based on a result of the first mathematical optimization, and a second mathematical optimization unit configured to execute second mathematical optimization of determining a start timing of each process on the substrate for the substrate processing unit or the substrate transport unit determined to execute the processes that are not simultaneously executable by the overlap determination unit by adding an exclusive processing condition for determining which process is prioritized between the two processes that are not simultaneously executable among the processes on the substrate to the constraint condition of the first mathematical optimization and using minimization of the processing time as an objective function of the mathematical optimization.

Another aspect of the present invention is a method executed by an information processing apparatus that generates substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates. The method includes: an information acquisition step of acquiring processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and a scheduling step of determining a start timing of each process on the substrate based on the processing time information acquired in the information acquisition step such that a processing time from a time at which transport of the first substrate from the substrate housing unit to the first substrate processing unit starts to a time at which transport of the last substrate from the last substrate processing unit to the substrate housing unit ends is minimized. The scheduling step includes a first mathematical optimization step of executing first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization, an overlap determination step of determining there is a substrate processing unit or a substrate transport unit executing processes that are not simultaneously executable based on a result of the first mathematical optimization, and a second mathematical optimization step of executing second mathematical optimization of determining a start timing of each process on the substrate for the substrate processing unit or the substrate transport unit determined to execute the processes that are not simultaneously executable in the overlap determination step by adding an exclusive processing condition for determining which process is prioritized between the two processes that are not simultaneously executable among the processes on the substrate to the constraint condition of the first mathematical optimization and using minimization of the processing time as an objective function of the mathematical optimization.

Still another aspect of the present invention is a program executed by an information processing apparatus that generates substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates, the program causing the information processing apparatus to execute: an information acquisition process of acquiring processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and a scheduling process of determining a start timing of each process on the substrate based on the processing time information acquired in the information acquisition process such that a processing time from a time at which transport of the first substrate from the substrate housing unit to the first substrate processing unit starts to a time at which transport of the last substrate from the last substrate processing unit to the substrate housing unit ends is minimized. The scheduling process includes a first mathematical optimization process of executing first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization, an overlap determination process of determining there is a substrate processing unit or a substrate transport unit executing processes that are not simultaneously executable based on a result of the first mathematical optimization, and a second mathematical optimization process of executing second mathematical optimization of determining a start timing of each process on the substrate on the substrate processing unit or the substrate transport unit determined to execute the processes that are not simultaneously executable in the overlap determination process by adding an exclusive processing condition for determining which process is prioritized between the two processes that are not simultaneously executable among the processes on the substrate to the constraint condition of the first mathematical optimization and using minimization of the processing time as an objective function of the mathematical optimization.

As will be described below, the present invention has other aspects. Accordingly, the disclosure of the invention is intended to provide some aspects of the invention and is not intended to limit the scope of the invention described and claimed herein.

### BRIEF DESCRIPTION OF DRAWINGS

FIG. 1 is a diagram illustrating a substrate processing system in which an information processing apparatus according to an embodiment of the present invention is used;

FIG. 2 is a diagram illustrating an information processing apparatus according to the embodiment of the present invention;

FIG. 3 is a diagram illustrating an example of a substrate processing unit (first and second polishing units) according to the embodiment of the present invention;

FIG. 4 is a diagram illustrating an example of a substrate processing unit (first finishing unit) according to the embodiment of the present invention;

FIG. 5 is a diagram illustrating an example of a substrate processing unit (second finishing unit) according to the embodiment of the present invention;

FIG. 6 is a diagram illustrating an example of a substrate processing unit (third finishing unit) according to the embodiment of the present invention;

FIG. 7 is a block diagram illustrating a configuration of an information processing apparatus according to the embodiment of the present invention;

FIGS. 8A to 8C are diagrams illustrating examples of overlap determination according to the embodiment of the present invention; and

FIG. 9 is a flowchart illustrating an operation of the information processing apparatus according to the embodiment of the present invention.

### DETAILED DESCRIPTION

Hereinafter, the present invention will be described in detail. Here, the following detailed description and the accompanying drawings do not limit the invention.

An information processing apparatus according to the present invention is an information processing apparatus that generates a substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates. The information processing apparatus includes: an information acquisition unit configured to acquire processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and a scheduling unit configured to determine a start timing of each process on the substrate based on the processing time information acquired by the information acquisition unit such that a processing time from a time at which transport of the first substrate from the substrate housing unit to the first substrate processing unit starts to a time at which transport of the last substrate from the last substrate processing unit to the substrate housing unit ends is minimized. The scheduling unit includes a first mathematical optimization unit configured to execute first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization, an overlap determination unit configured to determine whether there is a substrate processing unit or a substrate transport unit executing processes that are not simultaneously executable based on a result of the first mathematical optimization, and a second mathematical optimization unit configured to execute second mathematical optimization of determining a start timing of each process on the substrate for the substrate processing unit or the substrate transport unit determined to execute the processes that are not simultaneously executable by the overlap determination unit by adding an exclusive processing condition for determining which process is prioritized between the two processes that are not simultaneously executable among the processes on the substrate to the constraint condition of the first mathematical optimization and using minimization of the processing time as an objective function of the mathematical optimization.

In the configuration, in the mathematical optimization for the plurality of substrate processing units and the substrate transport unit, the mathematical optimization (first mathematical optimization) is executed without setting the exclusive processing condition for selecting one of two processes that are not simultaneously executable among the processes on the substrates as the constraint condition of the mathematical optimization. Therefore, it is possible to significantly shorten a time as compared with a case where the exclusive processing condition is set as the constraint condition of the mathematical optimization. Then, as a result of the mathematical optimization (first mathematical optimization), only for the substrate processing unit or the substrate transport unit determined to execute the processes that are not simultaneously executable, the mathematical optimization (second mathematical optimization) is executed in which the exclusive processing condition for determining which process is prioritized between the two processes that are not simultaneously executable is added to the constraint condition of the first mathematical optimization, and thus only the overlapping process is added to the constraint condition. Therefore, it is possible to shorten a calculation time (as compared with a case where two processes that do not overlap as a result are specified in advance as processes that are not simultaneously executable and are used as a constraint condition as in the related art). In this way, by shortening the time required for mathematical optimization, it is possible to generate the substrate processing schedule in a short time.

In the information processing apparatus according to the present invention, the processing time required for each process on the substrate may include a use time which is a time for the substrate processing or a time for the substrate transport, and a predetermined time margin set before and after the use time. For one of the substrate processing units and the substrate transport unit, the overlap determination unit may determine that the substrate processing unit or the substrate transport unit executes processes that are not simultaneously executable when a use time for a certain substrate overlaps a use time for another substrate.

In the configuration, when the use time for a certain substrate overlaps the use time for another substrate, the processes are determined not to be simultaneously executable, and the mathematical optimization (second mathematical optimization) is executed in which the exclusive processing condition for determining which process is prioritized between the two processes that are not simultaneously executable is added to the constraint condition of the first mathematical optimization for only the substrate processing unit or the substrate transport unit. Accordingly, it is possible to shorten a time required for the mathematical optimization and generate the substrate processing schedule in a short time.

In the information processing apparatus of the present invention, the processing time required for each process on the substrate may include a use time which is a time for the substrate processing or a time for the substrate transport, and a predetermined time margin set before and after the use time, and for one of the substrate processing units and the substrate transport unit, the overlap determination unit may determine that the substrate processing unit or the substrate transport unit executes processes that are not simultaneously executable when a use time for a certain substrate overlaps a time margin for another substrate.

In the configuration, when the use time for a certain substrate overlaps the time margin for another substrate, the processes are determined not to be simultaneously executable, and the mathematical optimization (second mathematical optimization) is executed in which the exclusive processing condition for determining which process is prioritized between the two processes that are not simultaneously executable is added to the constraint condition of the first mathematical optimization for only the substrate processing unit or the substrate transport unit. Accordingly, it is possible to shorten a time required for the mathematical optimization and generate the substrate processing schedule in a short time.

Further, in the information processing apparatus of the present invention, the processing time required for each process on the substrate may include a use time which is a time for the substrate processing or a time for the substrate transport, and a predetermined time margin set before and after the use time. For one of the substrate processing units and the substrate transport unit, the overlap determination unit may determine that the substrate processing unit or the substrate transport unit executes processes that are not simultaneously executable when a time margin for a certain substrate overlaps a time margin for another substrate.

In the configuration, when a time margin for a certain substrate overlaps a time margin for another substrate, the processes are determined not to be simultaneously executable, and the mathematical optimization (second mathematical optimization) is executed in which the exclusive processing condition for determining which process is prioritized between the two processes that are not simultaneously executable is added to the constraint condition of the first mathematical optimization for only the substrate processing unit or the substrate transport unit. Accordingly, it is possible to shorten a time required for the mathematical optimization and generate the substrate processing schedule in a short time.

Further, in the information processing apparatus of the present invention, the overlap determination unit may determine whether there is a substrate transport unit executing transport processes that are not simultaneously executable based on a result of the first mathematical optimization. The second mathematical optimization unit may determine a start timing of a transport process on the substrate for the substrate transport unit determined to execute the transport processes that are not simultaneously executable by the overlap determination unit by adding an exclusive processing condition for determining which process is prioritized between the two processes that are not simultaneously executable among the processes on the substrate to the constraint condition of the first mathematical optimization and using minimization of the processing time as an objective function of the mathematical optimization.

In the configuration, the mathematical optimization (second mathematical optimization) in which the exclusive processing condition for determining which process is prioritized between the two processes that are not simultaneously executable is added to the constraint condition of the first mathematical optimization is executed only for the substrate transport unit determined to execute the transport processes that are not simultaneously executable. Accordingly, it is possible to shorten a time required for the mathematical optimization and generate the substrate processing schedule in a short time.

A method according to the present invention is executed by an information processing apparatus that generates substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates. The method includes: an information acquisition step of acquiring processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and a scheduling step of determining a start timing of each process on the substrate based on the processing time information acquired in the information acquisition step such that a processing time from a time at which transport of the first substrate from the substrate housing unit to the first substrate processing unit starts to a time at which transport of the last substrate from the last substrate processing unit to the substrate housing unit ends is minimized. The scheduling step includes a first mathematical optimization step of executing first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization, an overlap determination step of determining there is a substrate processing unit or a substrate transport unit executing processes that are not simultaneously executable based on a result of the first mathematical optimization, and a second mathematical optimization step of executing second mathematical optimization of determining a start timing of each process on the substrate for the substrate processing unit or the substrate transport unit determined to execute the processes that are not simultaneously executable in the overlap determination step by adding an exclusive processing condition for determining which process is prioritized between the two processes that are not simultaneously executable among the processes on the substrate to the constraint condition of the first mathematical optimization and using minimization of the processing time as an objective function of the mathematical optimization.

According to this method, similarly to the above device, in the mathematical optimization for the plurality of substrate processing units and the substrate transport unit, the mathematical optimization (first mathematical optimization) is executed without setting the exclusive processing condition for selecting one of two processes that are not simultaneously executable among the processes on the substrates as the constraint condition of the mathematical optimization. Therefore, it is possible to significantly shorten a time as compared with a case where the exclusive processing condition is set as the constraint condition of the mathematical optimization. Then, as a result of the mathematical optimization (first mathematical optimization), only for the substrate processing unit or the substrate transport unit determined to execute the processes that are not simultaneously executable, the mathematical optimization (second mathematical optimization) is executed in which the exclusive processing condition for determining which process is prioritized between the two processes that are not simultaneously executable is added to the constraint condition of the first mathematical optimization, and thus only the overlapping process is added to the constraint condition. Therefore, it is possible to shorten a calculation time (as compared with a case where two processes that do not overlap as a result are specified in advance as processes that are not simultaneously executable and are used as a constraint condition as in the related art). In this way, by shortening the time required for mathematical optimization, it is possible to generate the substrate processing schedule in a short time.

A program according to the present invention is executed by an information processing apparatus that generates substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates, the program causing the information processing apparatus to execute: an information acquisition process of acquiring processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and a scheduling process of determining a start timing of each process on the substrate based on the processing time information acquired in the information acquisition process such that a processing time from a time at which transport of the first substrate from the substrate housing unit to the first substrate processing unit starts to a time at which transport of the last substrate from the last substrate processing unit to the substrate housing unit ends is minimized. The scheduling process includes a first mathematical optimization process of executing first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization, an overlap determination process of determining there is a substrate processing unit or a substrate transport unit executing processes that are not simultaneously executable based on a result of the first mathematical optimization, and a second mathematical optimization process of executing second mathematical optimization of determining a start timing of each process on the substrate on the substrate processing unit or the substrate transport unit determined to execute the processes that are not simultaneously executable in the overlap determination process by adding an exclusive processing condition for determining which process is prioritized between the two processes that are not simultaneously executable among the processes on the substrate to the constraint condition of the first mathematical optimization and using minimization of the processing time as an objective function of the mathematical optimization.

According to this program, similarly to the above device, in the mathematical optimization for the plurality of substrate processing units and the substrate transport unit, the mathematical optimization (first mathematical optimization) is executed without setting the exclusive processing condition for selecting one of two processes that are not simultaneously executable among the processes on the substrates as the constraint condition of the mathematical optimization. Therefore, it is possible to significantly shorten a time as compared with a case where the exclusive processing condition is set as the constraint condition of the mathematical optimization. Then, as a result of the mathematical optimization (first mathematical optimization), only for the substrate processing unit or the substrate transport unit determined to execute the processes that are not simultaneously executable, the mathematical optimization (second mathematical optimization) is executed in which the exclusive processing condition for determining which process is prioritized between the two processes that are not simultaneously executable is added to the constraint condition of the first mathematical optimization, and thus only the overlapping process is added to the constraint condition. Therefore, it is possible to shorten a calculation time (as compared with a case where two processes that do not overlap as a result are specified in advance as processes that are not simultaneously executable and are used as a constraint condition as in the related art). In this way, by shortening the time required for mathematical optimization, it is possible to generate the substrate processing schedule in a short time.

According to the present invention, by shortening the time required for mathematical optimization, it is possible to generate the substrate processing schedule in a short time.

### Embodiment

Hereinafter, an information processing apparatus according to an embodiment of the present invention will be described with reference to the drawings. In the present embodiment, a case of an information processing apparatus used in a substrate processing system or the like that processes a substrate such as a semiconductor wafer will be exemplified. The information processing apparatus according to the present embodiment has a function of generating a substrate processing schedule. This function is realized by a program stored in a storage medium such as a memory area of the information processing apparatus.

### Information Processing System

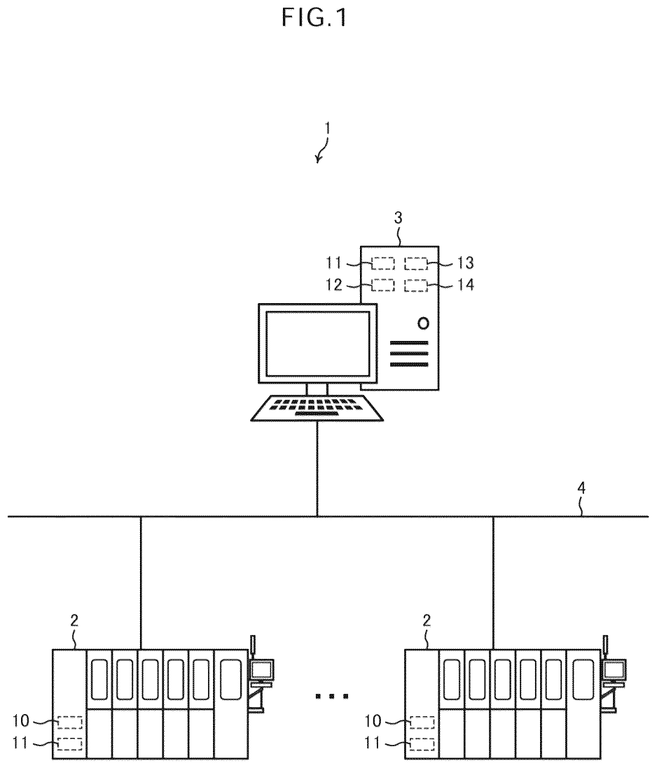

FIG. 1 is an overall configuration diagram illustrating an example of a substrate processing system 1. The substrate processing system 1 according to the present embodiment includes, as a main configuration, a substrate processing apparatus 2 and an information processing apparatus 3 and is connected to a wired or wireless network 4 to be able to mutually transmit and receive various types of data. The number of substrate processing apparatuses 2 and the number of information processing apparatuses 3 and a connection configuration of the network 4 are not limited to examples of FIG. 1, and may be appropriately changed. The information processing apparatus 3 may not be separate from the substrate processing apparatus 2 and may be provided in a part of the substrate processing apparatus 2 (which is, for example, a functional module).

The substrate processing apparatus 2 includes a plurality of processing units (of which details will be described below) that execute various types of processes on a substrate (hereinafter referred to as a “wafer”) W such as a semiconductor wafer, and operates each processing unit to execute a chemical mechanical polishing process (hereinafter referred to as a “polishing process”), a finishing process, a transport process, and the like on the wafer W. At that time, the substrate processing apparatus 2 controls an operation of each processing unit with reference to apparatus setting information 10 including a plurality of apparatus parameters set for each processing unit and a substrate recipe information 11 defining the operation of the polishing process and the finishing process.

The information processing apparatus 3 is a terminal apparatus used by a user, and is configured as a stationary or portable apparatus. For example, the information processing apparatus 3 receives various input operations through a display screen such as an application program or a web browser, and displays various types of information through the display screen.

The information processing apparatus 3 is an apparatus that supports a simulation during an automatic operation of the substrate processing apparatus 2 and formulation of a production plan by generating a substrate processing schedule 13 when processes are sequentially executed on a predetermined number of wafers W in the substrate processing apparatus 2, and calculating an evaluation index 14 of the substrate processing schedule 13 based on the substrate recipe information 11, a transport time information 12 indicating a time required for a transport process, and the like. The information processing apparatus 3 may be configured as a server type or a cloud type apparatus. In that case, the information processing apparatus 3 may operate in cooperation with a user terminal apparatus (not illustrated) on a client side.

### Substrate Processing Apparatus

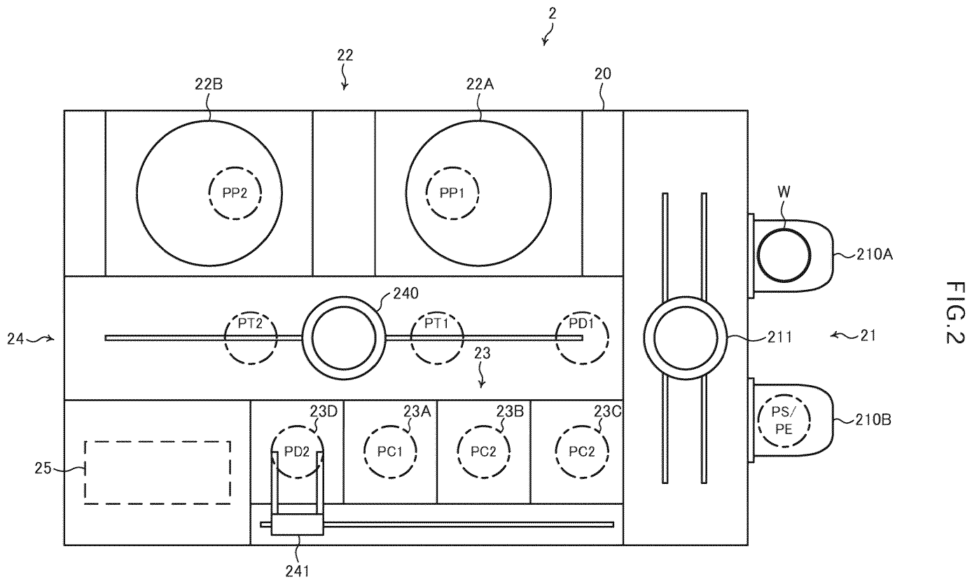

FIG. 2 is a schematic plan view illustrating an example of the substrate processing apparatus 2. The substrate processing apparatus 2 includes a load/unload unit 21, a polishing unit 22, a finishing unit 23, a substrate transport unit 24, and a control unit 25 inside a housing 20 that has a substantially rectangular shape in a plan view.

### Load/Unload Unit

The load/unload unit 21 includes first and second front load units 210A and 210B on which a wafer cassette (FOUP or the like) capable of storing a large number of wafers W in the vertical direction is placed, and an import/export robot 211 serving as a transport unit that is movable in a storage direction (vertical direction) of the wafers W stored in the wafer cassette and an arrangement direction of the first and second front load units 210A and 210B (the transverse direction of the housing 20). The first and second front load units 210A and 210B correspond to a substrate housing unit according to the present invention. In the present embodiment, the wafer W before process may be transported from the first front load unit 210A, and the wafer W after the process may be transported to the second front load unit 210B. That is, in the present invention, the substrate housing unit in which the substrate before the process is housed and the substrate housing unit in which the substrate after the process is housed are not necessarily the same substrate housing unit.

The import/export robot 211 is configured to be able to access a substrate import position PS, a first substrate transfer position PD1, the finishing unit 23 (specifically, a finishing unit 23C in a most downstream process to be described below), and a substrate export position PE. The import/export robot 211 includes two upper and lower stages of hands (not illustrated) for transferring the wafer W. The lower hand is used when the wafer W before process is transferred, and the upper hand is used when the wafer W after the process is transferred.

The substrate import position PS and the substrate export position PE are positions of wafer cassettes placed on the first and second front load units 210A and 210B, respectively. The import/export robot 211 executes an import process of importing the wafer W from the wafer cassette serving as the substrate import position PS to the first substrate transfer position PD1 and an export process of exporting the wafer W after the finishing process from the finishing unit 23 to the wafer cassette serving as the substrate export position PE as the transport process of the wafer W. The substrate import position PS and the substrate export position PE may be the same position or different positions.

### Polishing Unit

The polishing unit 22 includes a plurality of (two in the present embodiment) polishing units 22A and 22B that execute a polishing process of the wafer W, respectively. In the present embodiment, the first and second polishing units 22A and 22B are arranged side by side in the longitudinal direction of the housing 20, and execute polishing process in parallel. The polishing unit 22 (polishing unit 22A and 22B) corresponds to a substrate processing unit according to the present invention.

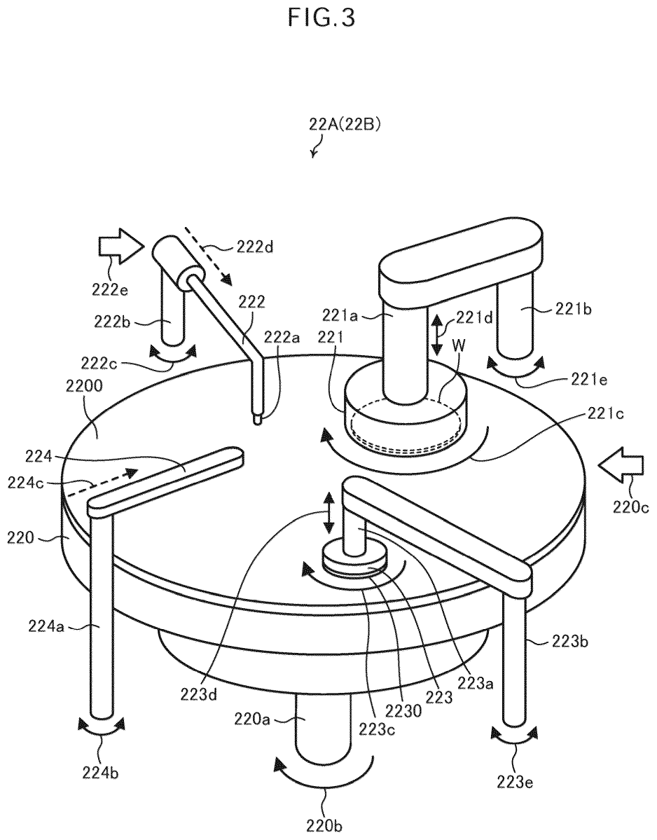

FIG. 3 is a perspective view illustrating examples of the first and second polishing units 22A and 22B. In the present embodiment, it is assumed that basic configurations and functions of the first and second polishing units 22A and 22B are common.

Each of the first and second polishing units 22A and 22B includes a polishing table 220 that rotatably supports the polishing pad 2200 that has a polishing surface, a top ring (substrate holding unit) 221 that rotatably holds the wafer W and polishes the wafer W while pressing the wafer W against the polishing pad 2200 on the polishing table 220, a polishing fluid supply unit 222 that supplies a polishing fluid to the polishing pad 2200, a dresser 223 that rotatably supports a dresser disk 2230 and brings the dresser disk 2230 into contact with the polishing surface of the polishing pad 2200 to dress the polishing pad 2200, and an atomizer 224 that injects a cleaning fluid to the polishing pad 2200.

The polishing table 220 includes a rotation moving mechanism 220b that is supported by a polishing table shaft 220a and rotationally drives the polishing table 220 around the axis, and a temperature adjustment mechanism 220c that adjusts a surface temperature of the polishing pad 2200.

The top ring 221 includes a rotation moving mechanism 221c that is supported by the top ring shaft 221a that movable in the vertical direction and rotationally drives the top ring 221 around the axis, a vertical moving mechanism 221d that moves the top ring 221 in the vertical direction, and a swing moving mechanism 221e that swings (oscillates) the top ring 221 about the support shaft 221b serving as a swing center. The rotation moving mechanism 221c, the vertical moving mechanism 221d, and the swing moving mechanism 221e function as a substrate moving mechanism that moves a relative position between the polishing pad 2200 and a polished surface of the wafer W.

The polishing fluid supply unit 222 includes a polishing fluid supply nozzle 222a that supplies a polishing fluid to the polishing surface of the polishing pad 2200, a swing movement mechanism 222c that is supported by a support shaft 222b and swings the polishing fluid supply nozzle 222a about the support shaft 222b serving as a swing center, a flow rate adjustment unit 222d that adjusts a flow rate of the polishing fluid, and a temperature adjustment mechanism 222e that adjusts a temperature of the polishing fluid. The polishing fluid is a polishing liquid (slurry) or pure water, and may further contain a chemical liquid, or may be a fluid obtained by adding a dispersant to the polishing liquid.

The dresser 223 includes a rotation moving mechanism 223c that is supported by the dresser shaft 223a movable in the vertical direction and drives the dresser 223 to rotate about the axis thereof, a vertical moving mechanism 223d that moves the dresser 223 in the vertical direction, and a swing moving mechanism 223e that swings the dresser 223 about the support shaft 223b serving as a swing center.

The atomizer 224 includes a swing moving mechanism 224b that is supported by the support shaft 224a and swings the atomizer 224 about the support shaft 224a serving as a swing center, and a flow rate adjustment unit 224c that adjusts a flow rate of a cleaning fluid. The cleaning fluid is a mixed fluid of a liquid (for example, pure water) and a gas (for example, a nitrogen gas) or a liquid (for example, pure water).

After the wafer W is adsorbed and held on the lower surface of the top ring 221 and is moved to predetermined polishing positions PP1 and PP2 on the polishing table 220, the wafer W is polished by being pressed by the top ring 221 against the polishing surface of the polishing pad 2200 to which the polishing fluid is supplied from the polishing fluid supply nozzle 222a.

### Finishing Unit

The finishing unit 23 includes a plurality of (three in the present embodiment) finishing units 23A to 23C that execute a finishing process of the wafer W, and a wafer station 23D in which the wafer W after the polishing process can stand by. The first to third finishing units 23A to 23C and the wafer station 23D are arranged side by side in the longitudinal direction of the housing 20, and the first to third finishing units 23A to 23C execute a finishing process in an arrangement order (finishing process order). The finishing unit 23 (first to third finishing units 23A to 23C) corresponds to a substrate processing unit according to the present invention.

In the present embodiment, the first finishing unit 23A executes a roll sponge cleaning process of cleaning the wafer W after the polishing process using a roll sponge 2300 as the finishing process of the most upstream process. The second finishing unit 23B executes a pen sponge cleaning process of cleaning the wafer W after the roll sponge cleaning process using a pen sponge 2301. The third finishing unit 23C executes a drying process of drying the wafer W after the pen sponge cleaning process as the finishing process of the most downstream process. The wafer station 23D holds the polished wafer W delivered from a polishing transporter 240 (of which details will be described below), and executes a standby process of causing the polished wafer W to stand by until the wafer W is delivered to a finishing transporter 241 (of which details will be described below). For example, the finishing process may start from the pen sponge cleaning process without the roll sponge cleaning process.

In place of or in addition to one of the first and second finishing units 23A and 23B, the finishing unit 23 may include a finishing unit (not illustrated) that executes a buff cleaning process of cleaning the wafer W using a buff, or one of the first and second finishing units 23A and 23B may be omitted. In the present embodiment, the first to third finishing units 23A to 23C are described to hold (horizontally hold) the wafer W horizontally, but may hold the wafer W vertically or obliquely.

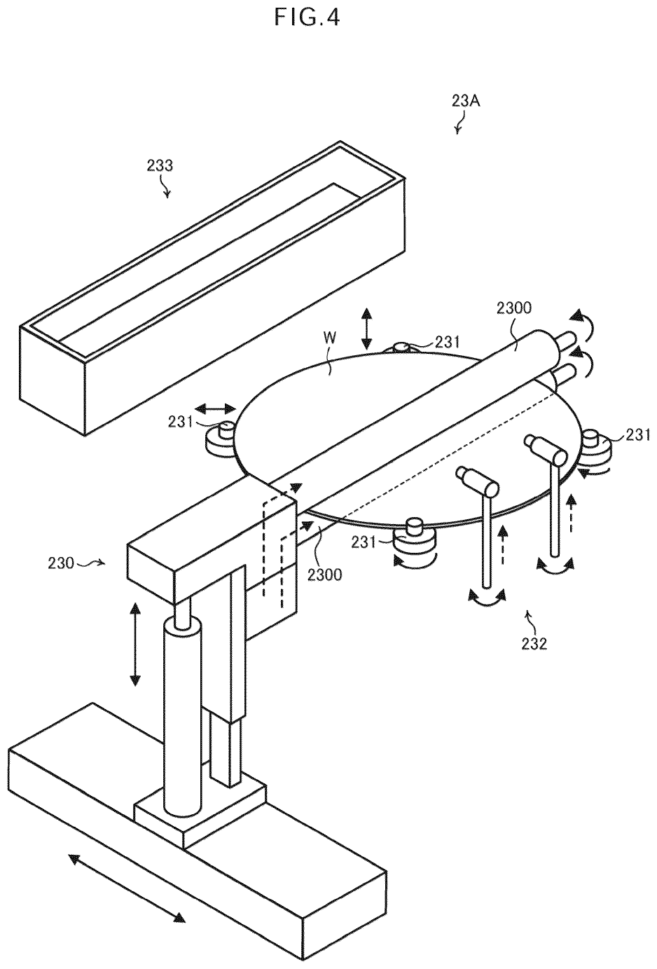

FIG. 4 is a perspective view illustrating an example of the first finishing unit 23A that executes a roll sponge cleaning process. The first finishing unit 23A includes a substrate cleaning unit 230 that rotatably supports the roll sponge 2300 and brings the roll sponge 2300 into contact with the wafer W to clean the wafer W, a substrate holding unit 231 that holds the wafer W, a cleaning fluid supply unit 232 that supplies a substrate cleaning fluid to the wafer W, and a cleaning tool cleaning unit 233 that cleans (self-cleans) the roll sponge 2300 with a cleaning tool cleaning fluid. The substrate cleaning fluid may be either pure water (rinse liquid) or a chemical liquid, may be a liquid, may be a binary fluid obtained by mixing a liquid and a gas, or may contain a solid such as dry ice. The cleaning tool cleaning fluid may be either pure water (rinse liquid) or a chemical solution.

In the roll sponge cleaning process by the first finishing unit 23A, the wafer W is rotated while being held at a first finishing position PC1 by the substrate holding unit 231. Then, in a state where the substrate cleaning fluid is supplied from the cleaning fluid supply unit 232 to a surface to be cleaned of the wafer W, the roll sponge 2300 rotated about the axis by the substrate cleaning unit 230 comes into sliding contact with the surface to be cleaned of the wafer W, whereby the wafer W is cleaned.

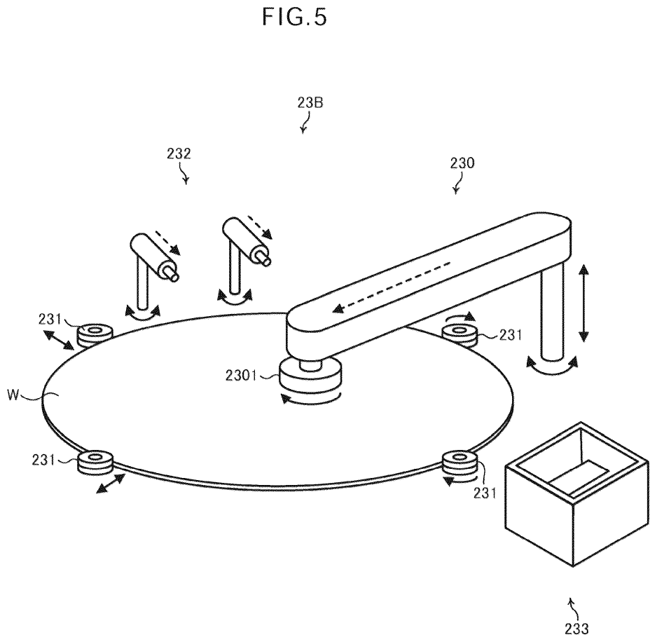

FIG. 5 is a perspective view illustrating an example of the second finishing unit 23B that executes a pen sponge cleaning process. The second finishing unit 23B includes a substrate cleaning unit 230 that rotatably supports the pen sponge 2301 and brings the pen sponge 2301 into contact with the wafer W to clean the wafer W, a substrate holding unit 231 that holds the wafer W, a cleaning fluid supply unit 232 that supplies a substrate cleaning fluid to the wafer W, and a cleaning tool cleaning unit 233 that cleans (self-cleans) the pen sponge 2301 with the cleaning tool cleaning fluid.

In the pen sponge cleaning process by the second finishing unit 23B, the wafer W is rotated while being held at a second finishing position PC2 by the substrate holding unit 231. Then, in a state where the substrate cleaning fluid is supplied from the cleaning fluid supply unit 232 to the surface to be cleaned of the wafer W, the pen sponge 2301 rotated about the axis by the substrate cleaning unit 230 comes into sliding contact with the surface to be cleaned of the wafer W to clean the wafer W.

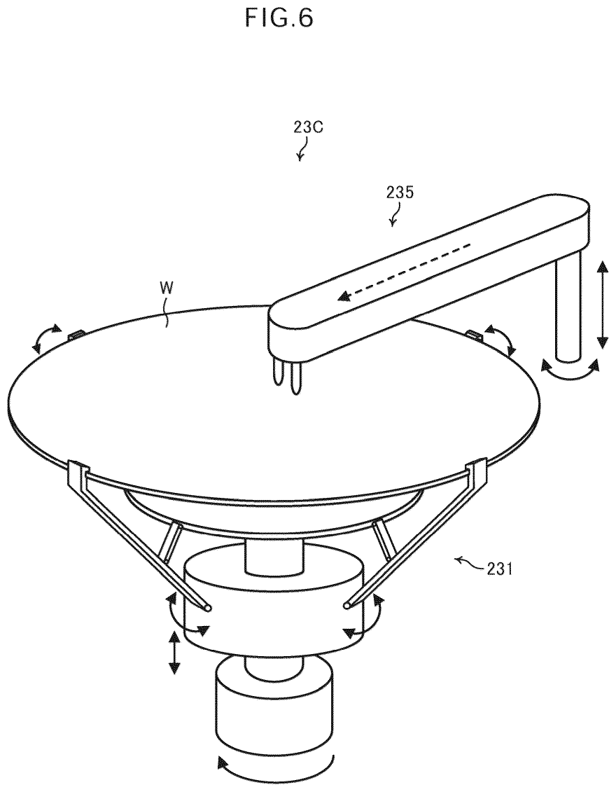

FIG. 6 is a perspective view illustrating an example of the third finishing unit 23C that executes a drying process. The third finishing unit 23C includes the substrate holding unit 231 that holds the wafer W, and a drying fluid supply unit 235 that supplies a substrate drying fluid to the wafer W. The substrate drying fluid is, for example, IPA vapor and pure water (rinse liquid), and may be a liquid, a binary fluid obtained by mixing a liquid and a gas, or may contain a solid such as dry ice.

In the drying process by the third finishing unit 23C, the wafer W is rotated while being held at a third finishing position PC3 by the substrate holding unit 231. In a state where the substrate drying fluid is supplied from the drying fluid supply unit 235 to the surface to be cleaned of the wafer W, the drying fluid supply unit 235 is moved to an edge side (radially outside) of the wafer W. Thereafter, the wafer W is rotated at a high speed to dry the wafer W.

### Substrate Transport Unit

As illustrated in FIG. 2, the substrate transport unit 24 includes the polishing transporter 240 serving as a transport unit that is movable in the arrangement direction of the first and second polishing units 22A and 22B (the longitudinal direction of the housing 20) and is capable of transferring the wafer W to the wafer station 23D serving as the second substrate transfer position PD2, and a finishing transporter 241 serving as a transport unit that is movable in the arrangement direction of the wafer station 23D and the first to third finishing units 23A to 23C (the longitudinal direction of the housing 20).

The polishing transporter 240 is configured to access the first substrate transfer position PD1, the first and second transport positions PT1 and PT2, and the second substrate transfer position PD2. Accordingly, as the transport process of the wafer W, the polishing transporter 240 executes a pre-polishing transport process of transporting the wafer W from the first substrate transfer position PD1 to the first and second polishing units 22A and 22B (in the present embodiment, the first and second transport positions PT1 and PT2) and a post-polishing transport process of transporting the wafer W after the polishing process from the first and second polishing units 22A and 22B (in the present embodiment, the first and second transport positions PT1 and PT2) to the second substrate transfer position PD2.

The first substrate transfer position PD1 is a position at which the wafer W is transferred between the import/export robot 211 and the polishing transporter 240. The first substrate transfer position PD1 is a position set on the import/export robot 211 side in a movement range of the polishing transporter 240 and is accessed by movement of the import/export robot 211.

At the first and second transport positions PT1 and PT2, there are loaders for delivering the wafers W to the top rings 221 of the first and second polishing units 22A and 22B, respectively. The first and second transport positions PT1 and PT2 are set at a predetermined interval in the movement range of the polishing transporter 240 and are positions at which the polishing transporter 240 delivers the wafer W to each loader. The first and second transport positions PT1 and PT2 are accessed by the top ring 221 of the first and second polishing units 22A and 22B being swung and moved.

The finishing transporter 241 is configured to be accessible to the second substrate transfer position PD2 and the first to third finishing units 23A to 23C. Therefore, as the transport process of the wafer W, the finishing transporter 241 executes a pre-finishing transport process of transporting the wafer W after the polishing process from the second substrate transfer position PD2 to the finishing unit 23A of the most upstream process, and a mid-finishing transport process of transporting the wafer W during the finishing process among the first to third finishing units 23A to 23C in a finishing order. In the present embodiment, the finishing transporter 241 executes, as the mid-finishing transport process, a first mid-finishing transport process of transporting the wafer W during the finishing process from the first finishing unit 23A to the second finishing unit 23B, and a second mid-finishing transport process of transporting the wafer W during the finishing process from the second finishing unit 23B to the third finishing unit 23C.

The second substrate transfer position PD2 is a position at which the wafer W is transferred between the polishing transporter 240 and the finishing transporter 241. The second substrate transfer position PD2 is a position set inside the wafer station 23D, and is accessed by the movement of the polishing transporter 240 and the finishing transporter 241.

### Information Processing Apparatus

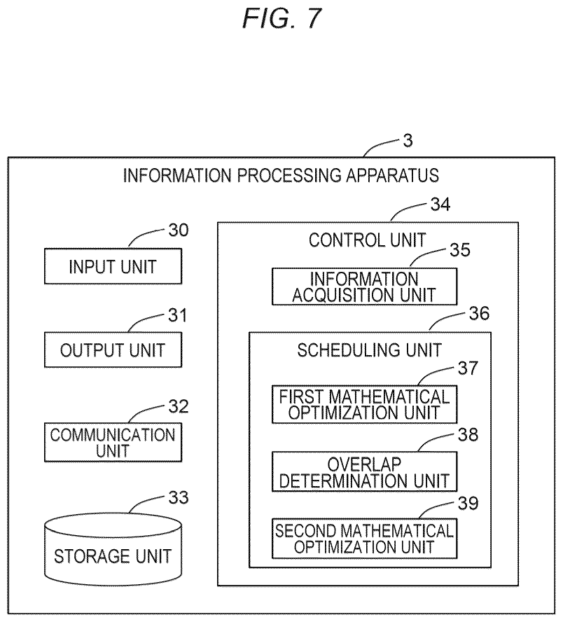

A configuration of the information processing apparatus 3 according to the present embodiment will be described with reference to the drawings. FIG. 7 is a block diagram illustrating a configuration of information processing apparatus 3 according to the present embodiment. As illustrated in FIG. 7, the information processing apparatus 3 includes an input unit 30, an output unit 31, a communication unit 32, a storage unit 33, and a control unit 34. The control unit 34 includes an information acquisition unit 35 and a scheduling unit 36 as functional blocks.

The input unit 30 has a function of receiving various input operations from the user and functions as an input user interface. The output unit 31 has a function of outputting various types of information via a display screen or voice and functions as an output user interface. The communication unit 32 is connected to an external apparatus (for example, the substrate processing apparatus 2) via the network 4 and functions as a communication interface that transmits and receives various types of data. The storage unit 33 stores various programs (an operating system, an information processing program, and the like) and various types of data (device setting information, substrate recipe information, transport time information, a substrate processing schedule, and the like) used for an operation of the information processing apparatus 3.

The information acquisition unit 35 has a function of acquiring processing time information indicating a processing time required for each process on the substrate, for example, by transmitting and receiving data to and from the substrate processing apparatus 2 via the communication unit 32 or referring to the storage unit 33. The processes on the substrates include a transport process of transporting the substrate from a substrate housing unit (the first and second front load units 210A and 210B) to a first substrate processing unit (the polishing unit 22A and 22B), substrate processing executed in a plurality of substrate processing units (the polishing units 22A and 22B and the first to third finishing units 23A to 23C), a transport process of transporting the substrate from the substrate processing unit first performing the substrate processing to the substrate processing unit subsequently performing the substrate processing, and a transport process of transporting the substrate from the last substrate processing unit (the first to third finishing units 23A to 23C) to the substrate housing unit (the first and second front load units 210A and 210B).

The processing time information includes information regarding a time required for substrate processing (a polishing process or a finishing process) (for example, the top ring pressing time by the top ring 221, a dresser operation time by the dresser 223, an atomizer operation time by the atomizer 224, a roll sponge operation time in the roll sponge cleaning process, a pen sponge operation time in the pen sponge cleaning process, a drying operation time in the drying process, a supply timing of the substrate drying fluid, or the like). These processing times may be set for each wafer W or may be set for every plurality of wafers that form a lot.

The processing time information includes information regarding a time required for the substrate transport process (a transport time required for each of an import process, a pre-polishing transport process, a post-polishing transport process, a pre-finishing transport process, a mid-finishing transport process, and an export process). The transport time may be, for example, an actual measurement value obtained by measuring a time when the transport unit (for example, the import/export robot 211, the polishing transporter 240, the finishing transporter 241, and a loader delivering the wafer W to the top ring 221 of the first and second polishing units 22A and 22B) actually operates or may be acquired from the substrate processing apparatus 2 or an external production management apparatus, for example, when the actual measurement value of the transport time is stored in the substrate processing apparatus 2 or the external production management apparatus. The transport time may be a theoretical value calculated from specifications of the transport unit. When apparatus setting information includes a moving speed of the transport unit, the apparatus setting information may be acquired from the substrate processing apparatus 2 or the storage unit 33 and the transport time may be calculated based on the apparatus setting information. Further, the transport time may be an inference value in consideration of an error (actual operation error) between the theoretical value and an actual measurement value when the transport unit actually operates. For example, the actual operation error may be calculated using an estimation model such as machine learning. The transport time information may be set for each wafer W or may be set for every plurality of wafers that form a lot.

The scheduling unit 36 has a function of determining a start timing of each process on the substrate based on the processing time information acquired by the information acquisition unit 35 such that a processing time (also referred to as processing completion time) from a time at which the first substrate starts to be transported from the substrate housing unit (the first and second front load units 210A and 210B) to the first substrate processing unit (the polishing unit 22A and 22B) (that is, after the first substrate is taken out) to a time transport of the last substrate from the last substrate processing unit (the first to third finishing units 23A to 23C) to the substrate housing unit (the first and second front load units 210A and 210B) ends is minimized. The scheduling unit 36 includes a first mathematical optimization unit 37, an overlap determination unit 38, and a second mathematical optimization unit 39 as functional blocks.

The first mathematical optimization unit 37 has a function of executing mathematical optimization (first mathematical optimization) for determining a start timing of each process on the substrates for all the substrate processing units (the polishing units 22A and 22B and the first to third finishing units 23A to 23C) and the substrate transport units (the import/export robot 211, the polishing transporter 240, and the finishing transporter 241) included in the substrate processing apparatus 2, by using minimization of maximum processing time as an objective function of the mathematical optimization without setting an exclusive processing condition for selecting one of two processes that are not simultaneously executable among the processes executed by the substrate processing unit and the substrate transport unit as a constraint condition of the mathematical optimization.

The overlap determination unit 38 has a function of determining whether there is a substrate processing unit (the polishing units 22A and 22B, the first to third finishing units 23A to 23C) or a substrate transport unit (the import/export robot 211, the polishing transporter 240, and the finishing transporter 241) executing processes that are not simultaneously executable based on a result of the first mathematical optimization.

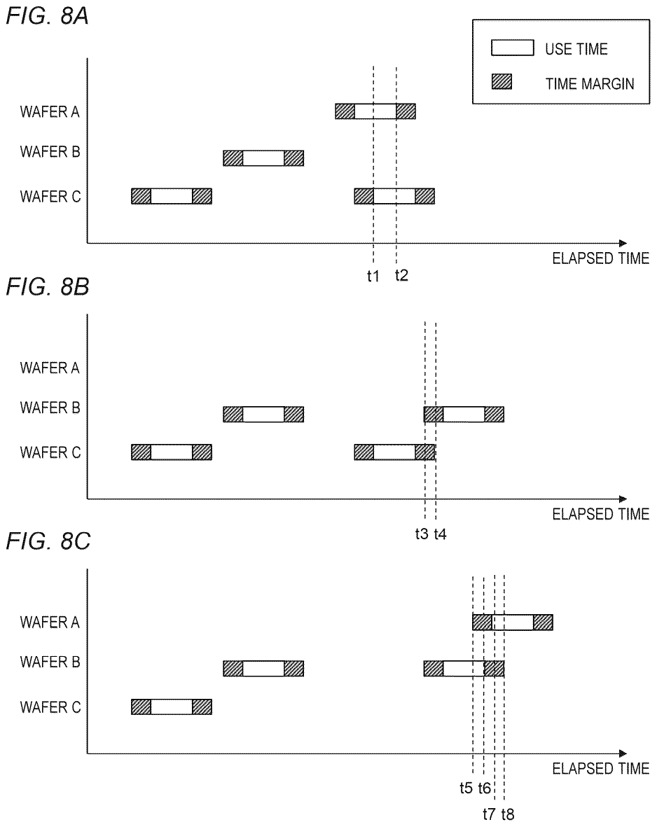

FIGS. 8A to 8C are diagrams illustrating examples of a processing time of a certain one substrate transport unit (for example, the polishing transporter 240) as a part of the result of the first mathematical optimization. As illustrated in FIGS. 8A to 8C, the processing time required for each process on the substrate includes a “use time” that is a time for substrate processing or a time for substrate transport, and a predetermined “time margin” set before and after the use time. The time margin may be zero.

When the use time for a certain substrate overlaps the use time for another substrate for one substrate processing unit or substrate transport unit, the overlap determination unit 38 can determine that the substrate processing unit or the substrate transport unit executes processes that are not simultaneously executable. The overlap determination unit 38 may set only the substrate transport unit (the import/export robot 211, the polishing transporter 240, and the finishing transporter 241) as an overlap determination target. That is, based on the result of the first mathematical optimization, the overlap determination unit 38 may determine only the presence or absence of the substrate transport unit executing the transport processes that are not simultaneously executable.

For example, in the example of FIG. 8A, the use time for the wafer A overlaps the use time for the wafer C between time t1 and time t2 for a certain one substrate transport unit (the polishing transporter 240). In this case, the overlap determination unit 38 determines that processes that are not simultaneously executable in the substrate transport unit (the import/export robot 211) are executed.

When a use time for a certain substrate overlaps a time margin for another substrate for one substrate processing unit or substrate transport unit, the overlap determination unit 38 can determine that the substrate processing unit or the substrate transport unit execute processes that are not simultaneously executable. In the example of FIG. 8B, the time margin for the wafer B overlaps the time margin for the wafer C in a period from time t3 to time t4 for one substrate transport unit (the import/export robot 211). In this case, the overlap determination unit 38 determines that processes that are not simultaneously executable in the substrate transport unit (the import/export robot 211) are executed.

When a time margin for a certain substrate overlaps a time margin for another substrate for one substrate processing unit or substrate transport unit, the overlap determination unit 38 can determine that the substrate processing unit or the substrate transport unit executes processes that are not simultaneously executable. In the example of FIG. 8C, for one substrate transport unit (the import/export robot 211), the time margin for the wafer A overlaps the use time for the wafer B from time t5 to time t6, and the use time for the wafer A overlaps the time margin for the wafer B from time t7 to time t8. (Between time t6 and time t7, the time margin for the wafer A also overlaps the time margin for the wafer B) In this case, the overlap determination unit 38 determines that the substrate transport unit (the import/export robot 211) executes processes that are not simultaneously executable.

The second mathematical optimization unit 39 has a function of executing mathematical optimization (second mathematical optimization) of determining a start timing of each process on the substrates by adding an exclusive processing condition for determining which process is prioritized between the two processes of the substrate processing unit or the substrate transport unit (for example, the import/export robot 211) determined to execute the processes that are not simultaneously executable by the overlap determination unit 38 to the constraint condition of the first mathematical optimization and using minimization of the maximum processing time as an objective function of the mathematical optimization.

Similarly to the overlap determination unit 38, the second mathematical optimization unit 39 may target only the substrate transport unit (the import/export robot 211, the polishing transporter 240, and the finishing transporter 241). That is, the second mathematical optimization unit 39 may determine the start timing of the transport process on the substrate for the substrate transport unit determined to execute the transport processes that are not simultaneously executable by the overlap determination unit 38 by adding an exclusive processing condition for determining which process is prioritized between the two processes that are not simultaneously executable among the processes on the substrate to the constraint condition of the first mathematical optimization and using minimization of the maximum processing time as an objective function of the mathematical optimization.

As a mathematical optimization scheme used in the first mathematical optimization unit 37 or the second mathematical optimization unit 39, for example, a mixed integer linear programming (MIP) may be used and another scheme may be used. Any search algorithm such as an exact method, an approximate method, or a heuristic method can be used as an optimal solution searching scheme.

The first mathematical optimization and the second mathematical optimization will be described with an example. A process in which the polishing transporter 240 takes an nth substrate polished by the polishing unit 22B from the loader PT2 and transports the nth substrate to the PD2 and a process in which an unpolished (n+m)th substrate is taken from the PD1 and transported to the loader PT1 (or PT2) cannot be executed simultaneously. In the first mathematical optimization, an overlap process that cannot be executed simultaneously is not set under a constraint condition. Therefore, it is likely to be determined that the two processes cannot be executed simultaneously for the transport schedule determined by the first mathematical optimization (when the processes are separated in time, the processes do not overlap). Then, in the second mathematical optimization, a condition selection (branch condition) is added to the constraint condition of the first mathematical optimization such that it can be determined which process is executed between the two processes to minimize the maximum processing time. The unselected process is incorporated into the transport schedule at a timing that does not overlap a period of time in which the selected process is executed. Alternatively, when there is another substrate processing unit or a substrate transport unit that can alternatively execute the unselected process, the substrate processing unit or the substrate transport unit is likely to be substituted.

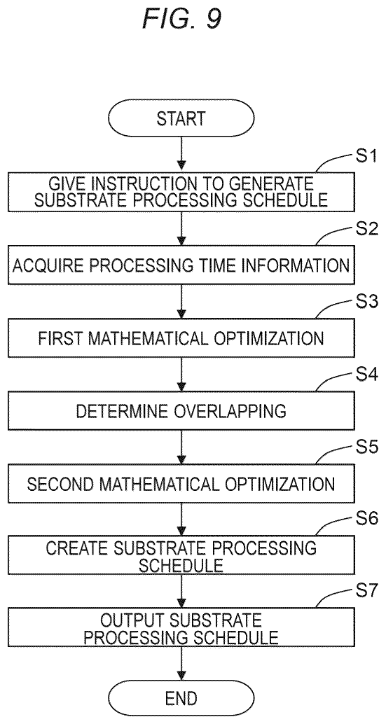

An operation of the information processing apparatus 3 configured as described above will be described with reference to the flowchart of FIG. 9.

When the substrate processing schedule is generated using the information processing apparatus 3 according to the embodiment of the present invention, first, for example, when a user instructs generation conditions (for example, a lot number of the wafer W that is an automatic operation target, a model number of the substrate processing apparatus 2 that executes an automatic operation, the number of processed sheets, and the like) of the substrate processing schedule on a substrate processing optimization screen displayed on the information processing apparatus 3 and gives an instruction to start generating the substrate processing schedule, the information processing apparatus 33 receives an input operation (S1).

Then, the information processing apparatus 33 acquires the processing time information indicating a processing time required for each process on the substrate by transmitting and receiving data to and from the substrate processing apparatus 2 via the communication unit 32 or referring to the storage unit 33 (S2).

Thereafter, the information processing apparatus 33 executes the first mathematical optimization (S1). That is, for all the substrate processing units (the polishing units 22A and 22B and the first to third finishing units 23A to 23C) and the substrate transport units (the import/export robot 211, the polishing transporter 240, and the finishing transporter 241) included in the substrate processing apparatus 2, a start timing of each process on the substrates is determined by using minimization of the maximum processing time as the objective function of the mathematical optimization without setting the exclusive processing condition for selecting one of two processes that are not simultaneously executable among the processes on the substrates as the constraint condition of the mathematical optimization.

Subsequently, the information processing apparatus 33 executes overlap determination based on a result of the first mathematical optimization (S4). That is, it is determined whether there is the substrate processing unit (the polishing units 22A and 22B and the first to third finishing units 23A to 23C) or the substrate transport unit (the import/export robot 211, the polishing transporter 240, and the finishing transporter 241) executing the processes that are not simultaneously executable.

Then, the information processing apparatus 33 executes the second mathematical optimization based on a result of the overlap determination (S5). That is, for the substrate processing unit or the substrate transport unit (for example, the import/export robot 211) for which the overlap determination unit 38 determines to execute the processes that are not simultaneously executable, the exclusive processing condition for determining which process is prioritized between the two processes that are not simultaneously executable among the processes on the substrates is added to the constraint condition of the first mathematical optimization, and a start timing of each process on the substrate is determined using minimization of setting the maximum processing time as an objective function of the mathematical optimization.

In the information processing apparatus 33, the substrate processing schedule is generated based on the start timing of each process determined as described above (S6). Then, the generated substrate processing schedule is output (S7).

In the information processing apparatus 3 according to the present embodiment, only the overlapping process is added to the constraint condition. Therefore, it is possible to shorten a calculation time (as compared with a case where two processes that do not overlap as a result are specified in advance as processes that are not simultaneously executable and are used as a constraint condition as in the related art). In this way, by shortening the time required for mathematical optimization, it is possible to generate the substrate processing schedule in a short time.

In the present embodiment, the mathematical optimization (second mathematical optimization) in which the exclusive processing condition for determining which process is prioritized between the two processes that are not simultaneously executable is added to the constraint condition of the first mathematical optimization is executed only for the substrate transport unit (the import/export robot 211, the polishing transporter 240, and the finishing transporter 241) determined to execute the transport processes that are not simultaneously executable. Accordingly, it is possible to shorten a time required for the mathematical optimization and generate the substrate processing schedule in a short time.

According to the present embodiment, as illustrated in FIG. 8A, when the use time for a certain substrate overlaps the use time for another substrate, the processes are determined not to be simultaneously executable, and the mathematical optimization (second mathematical optimization) in which the exclusive processing condition for determining which process is prioritized between the two processes that are not simultaneously executable is added to the constraint condition of the first mathematical optimization is executed for only the substrate processing unit or the substrate transport unit. Accordingly, it is possible to shorten a time required for the mathematical optimization and generate the substrate processing schedule in a short time.

According to the present embodiment, as illustrated in FIG. 8B, when the use time for a certain substrate overlaps the time margin for another substrate, the processes are determined not to be simultaneously executable, and the mathematical optimization (second mathematical optimization) is executed in which the exclusive processing condition for determining which process is prioritized between the two processes that are not simultaneously executable is added to the constraint condition of the first mathematical optimization for only the substrate processing unit or the substrate transport unit. Accordingly, it is possible to shorten a time required for the mathematical optimization and generate the substrate processing schedule in a short time.

In addition, in the present embodiment, as illustrated in FIG. 8C, when the time margin for a certain substrate overlaps the time margin for another substrate, the processes are determined not to be simultaneously executable, and the mathematical optimization (second mathematical optimization) is executed in which the exclusive processing condition for determining which process is prioritized between the two processes that are not simultaneously executable is added to the constraint condition of the first mathematical optimization for only the substrate processing unit or the substrate transport unit. Accordingly, it is possible to shorten a time required for the mathematical optimization and generate the substrate processing schedule in a short time.

Although the embodiments of the present invention have been described above by way of example, the scope of the present invention is not limited thereto, and can be changed and modified according to the object within the scope described in the claims.

### INDUSTRIAL APPLICABILITY

As described above, the information processing apparatus according to the present invention has an effect of being able to generate a substrate processing schedule in a short time by shortening the time required for mathematical optimization, and is used and useful for a substrate processing system or the like that processes a substrate such as a semiconductor wafer.

### REFERENCE SIGNS LIST

1 Substrate processing system
2 Substrate processing apparatus
20 Housing
21 Load/unload unit (substrate housing unit)
22 Polishing unit (substrate processing unit)
23 Finishing unit (substrate processing unit)
24 Substrate transport unit
25 Control unit
3 Information processing apparatus
30 Input unit
31 Output unit
32 Communication unit
33 Storage unit
34 Control unit
35 Information acquisition unit
36 Scheduling unit
37 First mathematical optimization unit
38 Overlap determination unit
39 Second mathematical optimization unit

What is claimed is:

1. An information processing apparatus that generates a substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates, the information processing apparatus comprising:
an information acquisition unit configured to acquire processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and
a scheduling unit configured to determine a start timing of each process on the substrate based on the processing time information acquired by the information acquisition unit such that a processing time from a time at which transport of the first substrate from the substrate housing unit to the first substrate processing unit starts to a time at which transport of the last substrate from the last substrate processing unit to the substrate housing unit ends is minimized, wherein
the scheduling unit includes
a first mathematical optimization unit configured to execute first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization,
an overlap determination unit configured to determine whether there is a substrate processing unit or a substrate transport unit executing processes that are not simultaneously executable based on a result of the first mathematical optimization, and
a second mathematical optimization unit configured to execute second mathematical optimization of determining a start timing of each process on the substrate for the substrate processing unit or the substrate transport unit determined to execute the processes that are not simultaneously executable by the overlap determination unit by adding an exclusive processing condition for determining which process is prioritized between the two processes that are not simultaneously executable among the processes on the substrate to the constraint condition of the first mathematical optimization and using minimization of the processing time as an objective function of the mathematical optimization.

2. The information processing apparatus according to claim 1, wherein
the processing time required for each process on the substrate includes a use time which is a time for the substrate processing or a time for the substrate transport, and a predetermined time margin set before and after the use time, and
for one of the substrate processing units or the substrate transport unit, the overlap determination unit determines that the substrate processing unit or the substrate transport unit executes processes that are not simultaneously executable when a use time for a certain substrate overlaps a use time for another substrate.

3. The information processing apparatus according to claim 1, wherein
the processing time required for each process on the substrate includes a use time which is a time for the substrate processing or a time for the substrate transport, and a predetermined time margin set before and after the use time, and
for one of the substrate processing units and the substrate transport unit, the overlap determination unit determines that the substrate processing unit or the substrate transport unit executes processes that are not simultaneously executable when a use time for a certain substrate overlaps a time margin for another substrate.

4. The information processing apparatus according to claim 1, wherein
the processing time required for each process on the substrate includes a use time which is a time for the substrate processing or a time for the substrate transport, and a predetermined time margin set before and after the use time, and
for one of the substrate processing units and the substrate transport unit, the overlap determination unit determines that the substrate processing unit or the substrate transport unit executes processes that are not simultaneously executable when a time margin for a certain substrate overlaps a time margin for another substrate.

5. The information processing apparatus according to claim 1, wherein
the overlap determination unit determines whether there is a substrate transport unit executing transport processes that are not simultaneously executable based on a result of the first mathematical optimization, and
the second mathematical optimization unit determines a start timing of a transport process on the substrate for the substrate transport unit determined to execute the transport processes that are not simultaneously executable by the overlap determination unit by adding an exclusive processing condition for determining which process is prioritized between the two processes that are not simultaneously executable among the processes on the substrate to the constraint condition of the first mathematical optimization and using minimization of the processing time as an objective function of the mathematical optimization.

6. A method executed by an information processing apparatus that generates substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates, the method comprising:
an information acquisition step of acquiring processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and
a scheduling step of determining a start timing of each process on the substrate based on the processing time information acquired in the information acquisition step such that a processing time from a time at which transport of the first substrate from the substrate housing unit to the first substrate processing unit starts to a time at which transport of the last substrate from the last substrate processing unit to the substrate housing unit ends is minimized, wherein
the scheduling step includes
a first mathematical optimization step of executing first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization,
an overlap determination step of determining there is a substrate processing unit or a substrate transport unit executing processes that are not simultaneously executable based on a result of the first mathematical optimization, and
a second mathematical optimization step of executing second mathematical optimization of determining a start timing of each process on the substrate for the substrate processing unit or the substrate transport unit determined to execute the processes that are not simultaneously executable in the overlap determination step by adding an exclusive processing condition for determining which process is prioritized between the two processes that are not simultaneously executable among the processes on the substrate to the constraint condition of the first mathematical optimization and using minimization of the processing time as an objective function of the mathematical optimization.

7. A program executed by an information processing apparatus that generates substrate processing schedule when a plurality of types of substrate processing are sequentially executed on a predetermined number of substrates in a substrate processing apparatus including a substrate housing unit in which the substrates are housed, a plurality of substrate processing units executing a plurality of types of different substrate processing on the substrates, and a substrate transport unit for transporting the substrates, the program causing the information processing apparatus to execute:
an information acquisition process of acquiring processing time information indicating a processing time required for each process on the substrate, the processes including a transport process of transporting the substrate from the substrate housing unit to a first substrate processing unit, each substrate processing executed by the plurality of substrate processing units, a transport process of transporting the substrate from a substrate processing unit that first executes the substrate processing to a substrate processing unit that subsequently executes the substrate processing, and a transport process of transporting the substrate from a last substrate processing unit to the substrate housing unit; and
a scheduling process of determining a start timing of each process on the substrate based on the processing time information acquired in the information acquisition process such that a processing time from a time at which transport of the first substrate from the substrate housing unit to the first substrate processing unit starts to a time at which transport of the last substrate from the last substrate processing unit to the substrate housing unit ends is minimized, wherein
the scheduling process includes
a first mathematical optimization process of executing first mathematical optimization for determining a start timing of each process on the substrate for the plurality of substrate processing units and the substrate transport unit by using minimization of the processing time as an objective function of the mathematical optimization without setting an exclusive processing condition for selecting one of two processes that are not simultaneously executable among the processes on the substrate as a constraint condition of the mathematical optimization,
an overlap determination process of determining there is a substrate processing unit or a substrate transport unit executing processes that are not simultaneously executable based on a result of the first mathematical optimization, and
a second mathematical optimization process of executing second mathematical optimization of determining a start timing of each process on the substrate on the substrate processing unit or the substrate transport unit determined to execute the processes that are not simultaneously executable in the overlap determination process by adding an exclusive processing condition for determining which process is prioritized between the two processes that are not simultaneously executable among the processes on the substrate to the constraint condition of the first mathematical optimization and using minimization of the processing time as an objective function of the mathematical optimization.
